(19) United States
(12) Patent Application Publication
(10) Pub. No.: US 2015/0106738 A1
(43) Pub. Date: Apr. 16, 2015

(54) SYSTEM AND METHOD FOR PROCESSING IMAGE OR AUDIO DATA

(71) Applicant: IWATCHLIFE INC., Ottawa (CA)

(72) Inventors: Charles Black, Gatineau (CA); Jason Phillips, Lower Sackville (CA); Robert Laganiere, Gatineau (CA); Pascal Blais, Ottawa (CA)

(21) Appl. No.: 14/395,420

(22) PCT Filed: Apr. 12, 2013
(86) PCT No.: PCT/CA2013/050287

§ 371 Date: Oct. 17, 2014

Related U.S. Application Data
(60) Provisional application No. 61/625,445, filed on Apr. 17, 2012.

(51) Int. Cl. G06F 3/0484; H04L 29/08

(52) U.S. Cl. CPC G06F 3/04842; H04L 67/12; H04L 67/10
USPC 715/748

(57) ABSTRACT

A system for performing video and or audio analytics includes a sensor at a source end. The sensor is for capturing sensor data comprising at least one of video data and audio data, and for providing at least a portion of the captured sensor data via a data output port thereof. The system also includes a data store having stored thereon machine-readable 5 instruction code comprising a plurality of different applications for processing at least one of video data and audio data. A user interface is provided for receiving an indication from a user, and for providing data relating to the indication to a processor, the data for selecting at least one of the plurality of different applications. The processor launches the at least one of the plurality of different applications and processes the provided at least a portion of 10 the captured sensor data in accordance therewith.

### FIELD OF THE INVENTION

The instant invention relates generally to systems and methods for processing image and/or audio data, and more particularly to systems and methods for processing image and/or audio data employing user-selectable applications.

### BACKGROUND OF THE INVENTION

Video cameras have been used in security and surveillance applications for several decades now, including for instance the monitoring of remote locations, entry/exit points of buildings and other restricted-access areas, high-value assets, public places and even private residences, etc. The use of video cameras continues to grow at an increasing rate, due in part to a perceived need to guard against terrorism and other criminal activities, but also due in part to the recent advancements that have been made in providing high-quality network cameras at ever-lower cost. Further, many consumer electronic devices that are on the market today are equipped with built-in cameras, which allow such devices to be used for other purposes during the times that they are not being used for their primary purpose. Similarly, microphones are widely available and are used to a lesser extent for security and surveillance applications, either as a stand-alone device or co-located with a video camera.

Although the ability to deploy video and/or audio based security and surveillance systems has now been extended even to individual property owners and small business owners, currently there are very few solutions available for processing the video and/or audio content that is captured using these small-scale systems. In contrast, for larger-scale systems such as the systems that are deployed in corporations, transit systems, government facilities, etc., subscription-based video analytics services are available for performing at least some of the required processing. Of course, typically the owners of larger-scale systems are better able to afford costly subscription services, and further they require more-or-less similar processing functions. The owners of small-scale systems are often unable or unwilling to pay regular subscription fees, and additionally the owners of different systems may require vastly different processing functions. For instance, some systems may be set up for purposes relating to security/surveillance whereas other systems may be set up for purposes relating to social media or entertainment. In some cases, it may be desired to process video and/or audio data in order to detect trigger events, whereas in other cases it may be desired to process video and/or audio data in order to modify the data or to overlay other data thereon, etc.

As video cameras and microphones are increasingly being incorporated into consumer electronic devices, including for instance smart phones, high definition televisions (HDTVs), automobiles, etc., it is likely that the demand for flexible and inexpensive processing solutions will increase. It would therefore be advantageous to provide a method and system that overcomes at least some of the above-mentioned limitations of the prior art.

### SUMMARY OF EMBODIMENTS OF THE INVENTION

In accordance with an aspect of the invention there is provided a system comprising: a sensor for capturing sensor data comprising at least one of video data and audio data and for providing at least a portion of the captured sensor data via a data output port thereof; a data store having stored thereon machine readable instruction code comprising a plurality of different applications for processing at least one of video data and audio data; a processor in communication with the sensor and with the data store; and a user interface in communication with the processor, the user interface for receiving an indication from the user and for providing data relating to the indication to the processor, the data for selecting at least one of the plurality of different applications for being executed by the processor for processing the provided at least a portion of the captured sensor data.

In accordance with an aspect of the invention there is provided a method comprising: using a sensor disposed at a source end, capturing sensor data comprising at least one of video data and audio data relating to an event that is occurring at the source end; transmitting at least a portion of the captured sensor data from the source end to a cloud-based processor via a wide area network (WAN); using a user interface that is disposed at the source end, selecting an application from a plurality of different applications for processing at least one of video data and audio data, the selected application for being executed on the cloud-based processor for processing the at least a portion of the captured sensor data; transmitting data indicative of the user selection from the source end to the cloud-based processor via the WAN; in response to receiving the data indicative of the user selection at the processor, launching the selected application; processing the least a portion of the captured sensor data in accordance with the selected application to generate result data; and transmitting the generated result data from the cloud-based processor to the source end via the WAN.

In accordance with an aspect of the invention there is provided a method comprising: transmitting first data comprising at least one of video data and audio data from a source end to a cloud-based processor via a wide area network (WAN); using a user interface at the source end, selecting from a plurality of different applications for processing at least one of video data and audio data: a first application for processing the first data to generate second data comprising at least one of video data and audio data; and a second application for processing the second data to generate results data; transmitting data indicative of the selected first and second applications from the source end to the cloud-based processor via the WAN; using the cloud-based processor, processing the first data using the first application to generate the second data; using the cloud-based processor, processing the second data using the second application to generate the results data; and transmitting the results data from the cloud-based processor to the source end via the WAN.

In accordance with an aspect of the invention there is provided a method comprising: using a sensor, capturing sensor data comprising at least one of video data and audio data relating to an event that is occurring locally with respect to the sensor; providing at least a portion of the captured sensor data from the sensor to a processor that is in communication with the sensor; using a user interface in communication with the processor, selecting by a user an application from a plurality of different applications for processing at least one of video data and audio data that are stored on a data store that is in communication with the processor, the selected application for being executed by the processor for processing the at least a portion of the captured sensor data; launching by the processor the selected application; processing by the processor the least a portion of the captured sensor data in accordance with the selected application, to generate result data; providing the result data to at least one of a display device and a sound generating device; and presenting to the user, via the at least one of a display device and a sound generating device, a human intelligible indication based on the result data.

In accordance with an aspect of the invention there is provided a system comprising: a sensor for capturing sensor data comprising at least one of video data and audio data and for providing at least a portion of the captured sensor data via a data output port thereof; a remote server in communication with the sensor via a wide area network (WAN); a data store in communication with the remote server and having stored thereon a database containing data relating to storage locations of a plurality of different applications for processing at least one of video data and audio data; and a user interface in communication with the remote server, the user interface for receiving an indication from the user and for providing data relating to the indication to the remote server, the data for selecting at least one of the plurality of different applications for processing the provided at least a portion of the captured sensor data, wherein the storage locations are indicative of other servers that are in communication with the remote server and a storage location of the selected at least one of the plurality of different applications is a first server of the other servers, and wherein during use the remote server provides the at least a portion of the captured sensor data to the first server of the other servers for being processed according to the selected at least one of the plurality of different applications.

In accordance with an aspect of the invention there is provided a method comprising: using a sensor, capturing sensor data comprising at least one of video data and audio data relating to an event that is occurring locally with respect to the sensor; providing at least a portion of the captured sensor data from the sensor to a remote server that is in communication with the sensor via a wide area network (WAN); using a user interface that is in communication with the remote server, selecting by a user an application from a plurality of different applications for processing at least one of video data and audio data; determining by the remote server a storage location of the selected application using a database containing data relating to storage locations of each of the plurality of different applications, the storage locations being indicative of other servers that are in communication with the remote server; and providing the at least a portion of the captured sensor data from the remote server to a first server that is determined to have stored in association therewith the selected application.

In accordance with an aspect of the invention there is provided a system comprising: a sensor for capturing sensor data comprising at least one of video data and audio data and for providing at least a portion of the captured sensor data via a data output port thereof; a data store having stored thereon machine readable instruction code comprising a plurality of different applications for processing at least one of video data and audio data; at least one processor in communication with the sensor and with the data store; and a user interface in communication with the at least one processor, the user interface for receiving an indication from the user and for providing data relating to the indication to the at least processor, the data for selecting at least one of the plurality of different applications for being executed by the at least one processor for processing the provided at least a portion of the captured sensor data.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1 is a simplified block diagram of a system according to an embodiment of the instant invention.

FIG. 2 is a simplified block diagram of a system according to an embodiment of the instant invention.

FIG. 3 is a simplified block diagram of a system according to an embodiment of the instant invention.

FIG. 4 is a simplified block diagram of a system according to an embodiment of the instant invention.

FIG. 5 is a simplified block diagram of a system according to an embodiment of the instant invention.

FIG. 6 is a simplified block diagram of a system according to an embodiment of the instant invention.

FIG. 7 is a simplified flow diagram of a method according to an embodiment of the instant invention.

FIG. 8 is a simplified flow diagram of a method according to an embodiment of the instant invention.

FIG. 9 is a simplified flow diagram of a method according to an embodiment of the instant invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

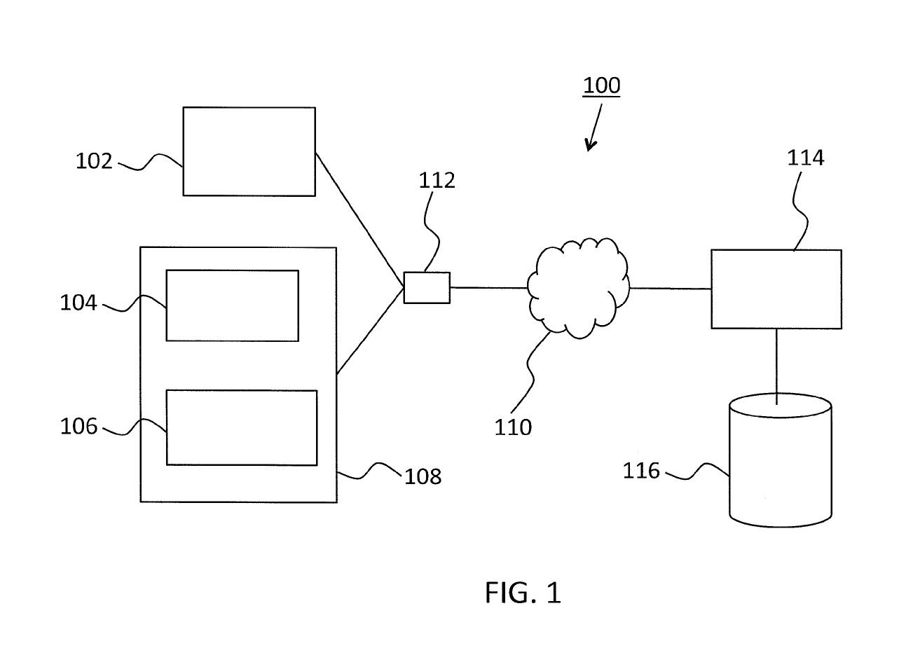

Referring to FIG. 1, shown is a simplified block diagram of a system in accordance with an embodiment of the instant invention. The system 100 includes a sensor 102 disposed at a source end for capturing sensor data, such as for instance at least one of video data and audio data. In this specific and non-limiting example the sensor 102 is a video camera, such as for instance a consumer grade Internet protocol (IP) video camera, for capturing video data. Alternatively, the sensor 102 is another type of image capture device or an audio capture device, e.g. a microphone. Optionally, a not illustrated data storage device is provided for storing a local copy of the captured sensor data at the source end. Further, a user interface 104 and an output device 106, such as for instance at least one of a display device and a sound-generating device or speaker, are also disposed at the source end. In the specific embodiment that is shown in FIG. 1, the user interface 104 and the output device 106 are integrated into a single device 108, such as for instance one of a smart phone, a tablet computer, a laptop computer, a desktop computer, a high definition television (HDTV), etc. Optionally, the user interface 104 and the output device 106 are provided as separate devices. For instance, in an alternative embodiment the user interface 104 is provided via one of a smart phone, a tablet computer, a laptop computer, a desktop computer etc., and the display device 106 is provided in the form of an HDTV.

The sensor 102, the user interface 104 and the output device 106 are connected to a local area network (LAN), which is in communication with a wide area network (WAN) 110 via network components that are shown generally at 112. A complete description of the network components 112 has been omitted from this discussion in the interest of clarity. Also connected to the WAN 110 is a cloud-based processor 114, which is in communication with a cloud-based data storage device 116. In an embodiment, the cloud-based processor 114 and cloud-based data storage device 116 are embodied in a network server. Optionally, the cloud-based processor 114 comprises a plurality of processors, such as for instance a server farm. Optionally, the cloud-based data storage device 116 comprises a plurality of separate network storage devices. The cloud-based data storage device 116 has stored thereon machine-readable instruction code, which comprises a plurality of different applications for processing video and/or audio data. Each of the plurality of different applications is executable by the cloud-based processor 114 for processing the video and/or audio data that are received from the source end, and/or for processing video and/or audio data that are generated using another one of the applications. That is to say, optionally the video and/or audio data is processed using a plurality of the applications in series.

During use, the sensor 102 is used to capture video data relating to an event that is occurring at the source end. The captured video data is provided to the cloud-based processor 114 via the network components 112 and the WAN 110. Optionally, the captured video data is “subscribed” to the cloud-based processor 114, in which case the captured video data is transmitted continuously or intermittently from the source end to the cloud-based processor 114. Alternatively, the captured video data is provided to the cloud-based processor 114 “on-demand,” such as for instance only when processing of the captured video data is required. Using the user interface 104, a user selects at least one of the applications that is stored on the cloud-based data storage device 116. For instance, the user interface 104 comprises a touch-screen display portion of a computing device, upon which ions that are representative of the available applications for processing video and/or audio data are displayed to the user. By touching an icon that is displayed on the touch-screen, the user provides an indication for selecting a desired application for processing the captured video data. A control signal is then transmitted from the source end to the cloud-based processor 114 via the network components 112 and the WAN 110, for launching the selected application. The processor 114 processes the captured video data in accordance with the selected application and result data is generated. The result data is transmitted to the output device 106, at the source end, via the WAN 110 and the network components 112. At the source end, the result data is presented to the user in a human intelligible form, via the output device. In the instant example, the output device 106 includes a display device, and the result data is displayed via the display device.

When the captured video and/or audio data are “subscribed” to the cloud-based processor, the selected application may be used to process the video/audio data continuously. Optionally, result data is transmitted from the cloud-based processor to the output device in a substantially continuous manner, or only when a predetermined trigger event is detected.

A specific and non-limiting example is provided below, in order to better illustrate the operation of the system of FIG. 1. In this specific example, a user places the sensor 102 so that it has a field of view (FOV) including a road that passes in front of his or her house. The sensor 102 captures video data, which is “subscribed” to the cloud-based processor 114. Using the user interface 104, the user selects a “speed trap” application that is stored on the cloud-based data storage device 116. The cloud-based processor 114 launches the “speed trap” application in dependence upon receiving a command signal that is transmitted from the source end via network components 112 and WAN 110. The “speed trap” application, when in execution on the cloud-based processor 114, is used to process the “subscribed” video data, thereby generating result data in the form of vehicle speed values that are based on video images of corresponding vehicles in the captured video data. Optionally, the result data is transmitted from the cloud-based processor 114 to the display device substantially continuously, in which case the user sees the speed of every vehicle that drives past his or her house. Alternatively, the result data is transmitted from the cloud-based processor 114 to the output device 106 only when a trigger event is detected. For instance, the result data is transmitted from the cloud-based processor 114 to the output device 106 only when a vehicle speed value exceeding the posted speed limit, or another threshold value, is determined.

Continuing with the instant example, optionally the result data that is generated by the “speed trap” application is provided to a second application that is also selected by the user. For instance, optionally the user selects a “license plate extraction” application, such that when the “speed trap” application detects a trigger event, the result data from the “speed trap” application is provided to the “license plate extraction” application. Thus, in dependence upon detecting the trigger event additional processing is performed in order to extract the license plate information of the vehicle to which the trigger event relates. Optionally, the “license plate extraction” application overlays the license plate information on the video data, such that the result data that is displayed via the output device 106 includes video of the vehicle with a visual indication of the vehicle speed and license plate information.

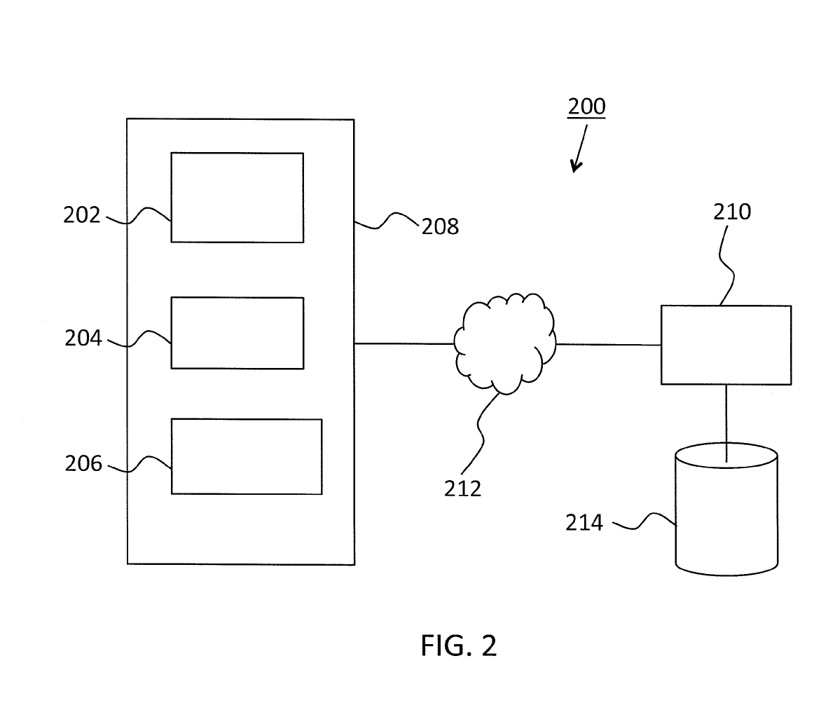

Referring now to FIG. 2, shown is a simplified block diagram of a system in accordance with another embodiment of the instant invention. The system 200 includes a sensor 202, a user interface 204 and an output device 206, such as for instance at least one of a display device and a sound-generating device or speaker, all of which are disposed at a source end. In this specific and non-limiting example the sensor 202 is an integrated video camera of a consumer electronic device 208, such as for instance one of a smart phone, a tablet computer, a laptop computer, a desktop computer, an HDTV, etc. Additionally, the user interface 204 and the output device 206 are embodied in the consumer electronic device 208. The user interface 604 comprises, by way of an example, a touch-screen display portion of the consumer electronic device 208. Optionally, the consumer electronic device 208 further includes a not illustrated data storage device for storing a local copy of the captured video data at the source end.

In the system that is shown in FIG. 2 the consumer electronic device 208 is in communication with a cloud-based processor 210 via a wide area network (WAN) 212. A complete description of the wired and/or wireless infrastructure that connects the consumer electronic device 208 to the WAN 212 has been omitted in FIG. 2, in the interest of clarity. The cloud-based processor 210 is in communication with a cloud-based data storage device 214. In an embodiment, the cloud-based processor 210 and cloud-based data storage device 214 are embodied in a network server. Optionally, the cloud-based processor 210 comprises a plurality of processors, such as for instance a server farm. Optionally, the cloud-based data storage device 214 comprises a plurality of separate network storage devices. The cloud-based data storage device 214 has stored thereon machine-readable instruction code, which comprises a plurality of different applications for processing video and/or audio data. Each of the plurality of different applications is executable by the cloud-based processor 210 for processing the video and/or audio data that are received from the source end, and/or for processing video and/or audio data that are generated using another one of the applications. That is to say, optionally the video and/or audio data are processed using a plurality of the applications in series.

The operation of the system that is shown in FIG. 2 is substantially the same as the operation of the system that is shown in FIG. 1. During use, the sensor 202 is used to capture video data relating to an event that is occurring at the source end. The captured video data is provided to the cloud-based processor 210 via the WAN 212. Optionally, the captured video data is “subscribed” to the cloud-based processor 210, in which case the captured video data is transmitted continuously or intermittently from the source end to the cloud-based processor 210. Alternatively, the captured video data is provided to the cloud-based processor 210 “on-demand,” such as for instance only when processing of the captured video data is required. Using the user interface 204, a user selects at least one of the applications that is stored on the cloud-based data storage device 214. For instance, the user interface 204 comprises a touch-screen display portion of a computing device, upon which ions that are representative of the available applications for processing video and/or audio data are displayed to the user. By touching an icon that is displayed on the touch-screen, the user provides an indication for selecting a desired application for processing the captured video data. A control signal is then transmitted from the source end to the cloud-based processor 210 via the WAN 212, for launching the selected application. The processor 210 processes the captured video data in accordance with the selected application and result data is generated. The result data is transmitted to the output device 206, at the source end, via the WAN 212. At the source end, the result data is presented to the user in a human intelligible form, via the output device 206. In the instant example, the output device 206 includes a display device, and the result data is displayed via the display device.

When the captured video and/or audio data is “subscribed” to the cloud-based processor, the selected application may be used to process the video and/or audio data continuously. Optionally, result data is transmitted from the cloud-based processor to the output device in a substantially continuous manner, or only when a predetermined trigger event is detected.

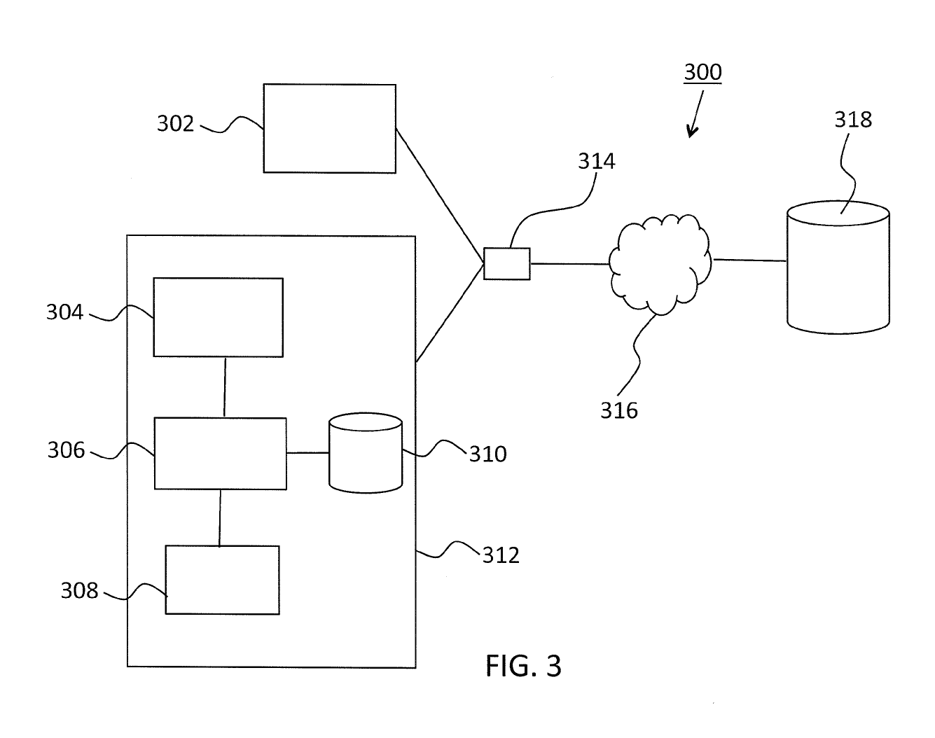

Referring now to FIG. 3, shown is a simplified block diagram of a system in accordance with another embodiment of the instant invention. The system 300 includes a sensor 302 disposed at a source end. In this specific and non-limiting example the sensor 302 is a video camera, such as for instance a consumer grade Internet protocol (IP) video camera, for capturing video data. Optionally, a not illustrated data storage device is provided for storing a local copy of the captured sensor data at the source end. Further, a user interface 304, a processor 306, a local data store 310, and an output device 306, such as for instance at least one of a display device and a sound-generating device or speaker, are also disposed at the source end. In the specific embodiment that is shown in FIG. 3, the user interface 304, the processor 306, the local data store 310 and the output device 308 are integrated into a consumer electronic device 312, such as for instance one of a smart phone, a tablet computer, a laptop computer, a desktop computer, a high definition television (HDTV), etc.

The sensor 302 and the consumer electronic device 312 are connected to a local area network (LAN), which is in communication with a wide area network (WAN) 316 via network components that are shown generally at 314. A complete description of the network components 314 has been omitted from this discussion in the interest of clarity. Also connected to the WAN 316 is a cloud-based data storage device 318. Optionally, the cloud-based data storage device 318 comprises a plurality of separate network storage devices. The cloud-based data storage device 318 has stored thereon machine-readable instruction code, which comprises a plurality of different applications for processing video and/or audio data. Each of the plurality of different applications is executable by the processor 306 for processing the video and/or audio data that are captured using the video/audio data capture device 302, and/or for processing video and/or audio data that are generated using another one of the applications. That is to say, optionally the video and/or audio data are processed using a plurality of the applications in series.

During use, the sensor 302 is used to capture video data relating to an event that is occurring at the source end. The captured video data is provided to the processor 306 via the LAN. Optionally, the captured video data is provided to the processor 306 substantially continuously or intermittently, but in an automated fashion. Alternatively, the captured video data is provided to the processor 306 “on-demand,” such as for instance only when processing of the captured video data is required. Using the user interface 304, a user selects at least one of the applications that is stored on the cloud-based data storage device 318. For instance, the user interface 304 comprises a touch-screen display portion of the consumer electronic device 312, upon which ions that are representative of the available applications for processing video and/or audio data are displayed to the user. By touching an icon that is displayed on the touch-screen, the user provides an indication for selecting a desired application for processing the captured video data. A control signal is then transmitted from the source end to the cloud-based data storage device 318 via the network components 314 and the WAN 316. The machine-readable code corresponding to the selected application is transmitted from the cloud-based data storage device 318 to the local data store 310 via the WAN and the network components 314. Subsequently, the processor 306 loads the machine-readable code from the local data store 310 and launches the selected application. Of course, if the machine-readable code corresponding to the selected application has been previously transmitted to and stored on the local data store 310, then selection of the application causes the processor 306 to load the machine-readable code from the local data store 310, without the machine-readable code being transmitted again from the cloud-based data storage device 318. The processor 306 processes the captured video data in accordance with the selected application and result data is generated. The result data is provided to the output device 308, and is presented to the user in a human intelligible form, via the output device 308. In the instant example, the output device 308 includes a display device, and the result data is displayed via the display device.

A specific and non-limiting example is provided below, in order to better illustrate the operation of the system of FIG. 3. In this specific example, a user places the sensor 302 so that it has a field of view (FOV) including a road that passes in front of his or her house. The sensor 302 captures video data, which are provided to the processor 306 via the LAN. Using the user interface 304, the user selects a “speed trap” application that is stored on the cloud-based data storage device 318. If not already stored on the local data store, data including the machine-readable instruction code for the “speed trap” application is transmitted to the local data store 310 and is stored thereon. The processor 306 launches the “speed trap” application in dependence upon the user selecting the “speed trap” application via the user interface 304. If the “speed trap” application has previously been downloaded and stored on the local data store 310, then the processor launches the “speed trap” application without first downloading the application from the cloud-based data storage device 318. The “speed trap” application, when in execution on the processor 306, is used to process the captured video data, thereby generating result data in the form of vehicle speed values that are based on video images of corresponding vehicles in the captured video data. The result data is provided to the output device 308 and is displayed to the user in a human intelligible form. Optionally, the result data is provided to and displayed via the output device 308 only when a trigger event is detected. For instance, the result data is provided to and displayed via the output device 308 only when a vehicle speed value exceeding the posted speed limit, or another threshold value, is determined during processing using the “speed trap” application.

Continuing with the instant example, optionally the result data that is generated by the “speed trap” application is provided to a second application that is also selected by the user. For instance, optionally the user selects a “license plate extraction” application, such that when the “speed trap” application detects a trigger event, the result data from the “speed trap” application is provided to the “license plate extraction” application. Thus, in dependence upon detecting the trigger event additional processing is performed in order to extract the license plate information of the vehicle to which the trigger event relates. Optionally, the “license plate extraction” application overlays the license plate information on the video data, such that the result data that is displayed via the output device 308 includes video of the vehicle with a visual indication of the vehicle speed and license plate information.

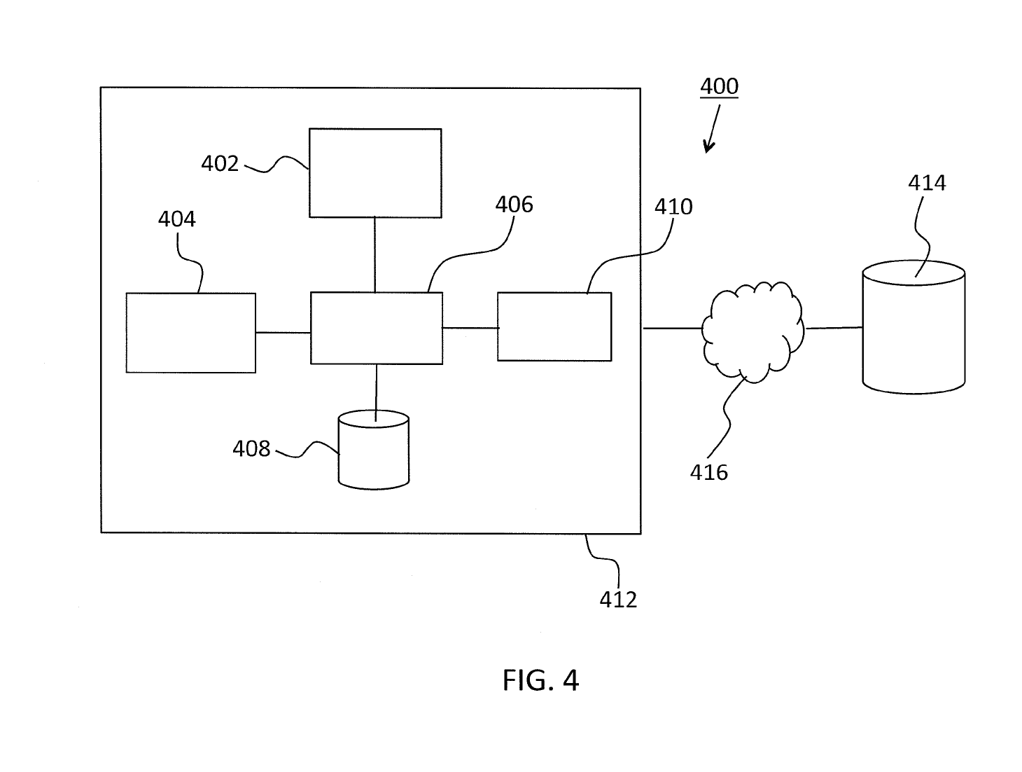

Referring now to FIG. 4, shown is a simplified block diagram of a system in accordance with another embodiment of the instant invention. The system 400 includes a sensor 402, a user interface 404, a processor 406, a local data store 408 and an output device 410, such as for instance at least one of a display device and a sound-generating device or speaker, all of which are disposed at a source end. In this specific and non-limiting example the sensor 402 is an integrated video camera of a consumer electronic device 412, such as for instance one of a smart phone, a tablet computer, a laptop computer, a desktop computer, an HDTV, etc. Additionally, the user interface 404, the processor 406, the local data store 408 and the output device 410 are embodied in the consumer electronic device 412. The user interface 404 comprises, by way of an example, a touch-screen display portion of the consumer electronic device 412.

In the system that is shown in FIG. 4 the consumer electronic device 412 is in communication with a cloud-based data storage device 414 via a wide area network (WAN) 416. A complete description of the wired and/or wireless infrastructure that connects the consumer electronic device 412 to the WAN 416 has been omitted in FIG. 4, in the interest of clarity. The cloud-based data storage device 414 has stored thereon machine-readable instruction code, which comprises a plurality of different applications for processing video and/or audio data. Each of the plurality of different applications is executable by the processor 406 for processing video and/or audio data that are captured using the sensor 402, and/or for processing video and/or audio data that are generated using another one of the applications. That is to say, optionally the video and/or audio data are processed using a plurality of the applications in series. Further optionally, the cloud-based data storage device 414 comprises a plurality of separate network storage devices.

The operation of the system that is shown in FIG. 4 is substantially the same as the operation of the system that is shown in FIG. 3. During use, the sensor 402 is used to capture video data relating to an event that is occurring at the source end. The captured video data is provided to the processor 406 via the LAN. Optionally, the captured video data is provided to the processor 406 substantially continuously or intermittently, but in an automated fashion. Alternatively, the captured video data is provided to the processor 406 “on-demand,” such as for instance only when processing of the captured video data is required. Using the user interface 404, a user selects at least one of the applications that is stored on the cloud-based data storage device 414. For instance, the user interface 404 comprises a touch-screen display portion of the consumer electronic device 412, upon which ions that are representative of the available applications for processing video and/or audio data are displayed to the user. By touching an icon that is displayed on the touch-screen, the user provides an indication for selecting a desired application for processing the captured video data. A control signal is then transmitted from the source end to the cloud-based data storage device 414 via the WAN 416. The machine-readable code corresponding to the selected application is transmitted from the cloud-based data storage device 414 to the local data store 408 via the WAN 416. Subsequently, the processor 406 loads the machine-readable code from the local data store 408 and launches the selected application. Of course, if the machine-readable code corresponding to the selected application has been previously transmitted to and stored on the local data store 408, then selection of the application causes the processor 406 to load the machine-readable code from the local data store 408, without the machine-readable code being transmitted again from the cloud-based data storage device 414. The processor 406 processes the captured video data in accordance with the selected application and result data is generated. The result data is provided to the output device 410, and is presented to the user in a human intelligible form, via the output device 410. In the instant example, the output device 410 includes a display device, and the result data is displayed via the display device.

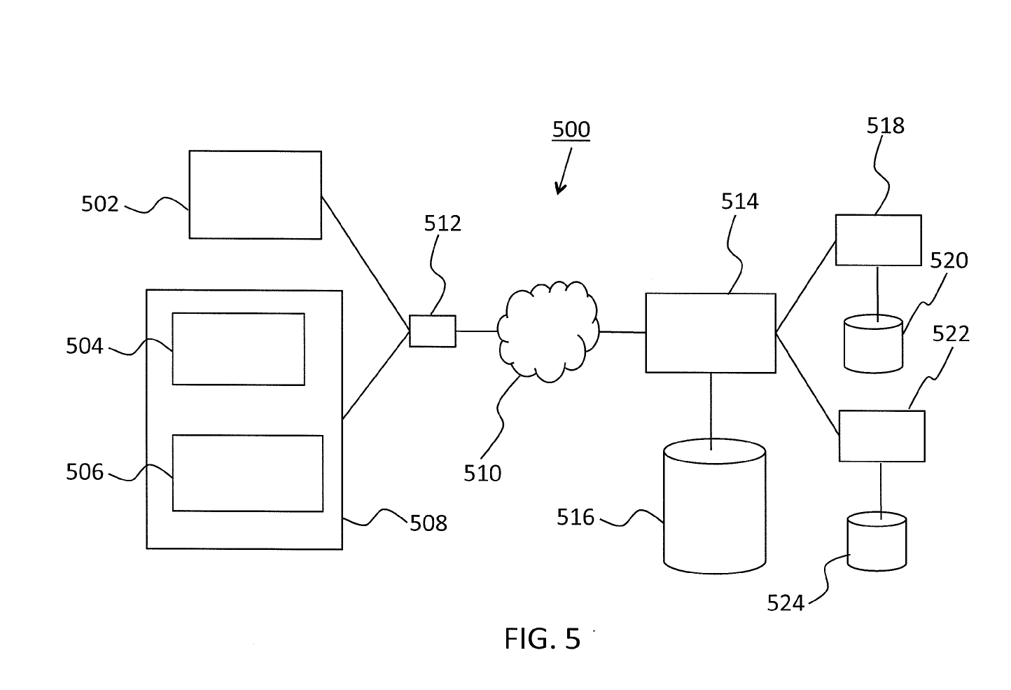

Referring to FIG. 5, shown is a simplified block diagram of a system in accordance with an embodiment of the instant invention. The system 500 includes a sensor 502 disposed at a source end for capturing sensor data, such as for instance at least one of video data and audio data. In this specific and non-limiting example the sensor 502 is a video camera, such as for instance a consumer grade Internet protocol (IP) video camera. Optionally, a not illustrated data storage device is provided for storing a local copy of the captured sensor data at the source end. Further, a user interface 504 and an output device 506, such as for instance at least one of a display device and a sound-generating device or speaker, are also disposed at the source end. In the specific embodiment that is shown in FIG. 5, the user interface 504 and the output device 506 are integrated into a single device 508, such as for instance one of a smart phone, a tablet computer, a laptop computer, a desktop computer, a high definition television (HDTV), etc. Optionally, the user interface 504 and the output device 506 are provided as separate devices. For instance, in an alternative embodiment the user interface 504 is provided via one of a smart phone, a tablet computer, a laptop computer, a desktop computer etc., and the display device 506 is provided in the form of an HDTV.

The sensor 502, the user interface 504 and the output device 506 are connected to a local area network (LAN), which is in communication with a wide area network (WAN) 510 via network components that are shown generally at 512. A complete description of the network components 512 has been omitted from this discussion in the interest of clarity. Also connected to the WAN 510 is a cloud-based processor 514, which is in communication with a cloud-based data storage device 516. In an embodiment, the cloud-based processor 514 and cloud-based data storage device 516 are embodied in a network server. Optionally, the cloud-based processor 514 comprises a plurality of processors, such as for instance a server farm. Optionally, the cloud-based data storage device 516 comprises a plurality of separate network storage devices. The cloud-based data storage device 516 has stored thereon a database relating to third party applications for processing video and/or audio data.

Referring still to FIG. 5, the cloud-based processor is in communication with a first third-party server 518 having a first local data store 520 and with a second third-party server 522 having a second local data store 524. At least a first third-party application for processing video and/or audio data is stored on the first local data store 520 and at least a second third-party application for processing video and/or audio data is stored on the second local data store 524. The first third-party application is executable by a processor of the first third-party server 518 for processing video and/or audio data that are received from the source end via the cloud-based processor 514. Similarly, the second third-party application is executable by a processor of the second third-party server 522 for processing video and/or audio data that are received from the source end via the cloud-based processor 514. Optionally the first third-party application and/or the second third party application process video and/or audio data that are generated using another application. That is to say, optionally the video and/or audio data are processed using a plurality of the applications in series.

During use, the sensor 502 is used to capture video data relating to an event that is occurring at the source end. The captured video data is provided to the cloud-based processor 514 via the network components 512 and the WAN 510. Optionally, the captured video data is “subscribed” to the cloud-based processor 514, in which case the captured video data is transmitted continuously or intermittently from the source end to the cloud-based processor 514. Alternatively, the captured video data is provided to the cloud-based processor 514 “on-demand,” such as for instance only when processing of the captured video data is required. Using the user interface 504, a user selects the first third-party application, which is stored on the first local data store 520. Alternatively, the user selects the second third-party application, which is stored on the second local data store 524. For instance, the user interface 504 comprises a touch-screen display portion of a computing device, upon which ions that are representative of the available applications for processing video and/or audio data are displayed to the user. By touching an icon that is displayed on the touch-screen, the user provides an indication for selecting a desired application for processing the captured video data. A control signal is then transmitted from the source end to the cloud-based processor 514 via the network components 512 and the WAN 510. The cloud-based processor 514 accesses the database that is stored on the cloud-based data storage device 516 and retrieves the location of the first third-party application. Subsequently, the cloud-based processor passes the captured video data, or at least a portion thereof, to the first third party server 518 with a request for processing the captured video data using the first third-party application. The first third-party server 518 receives the captured video data and launches the first third-party application, which is stored on the first local data store 520. The captured video data is processed in accordance with the first third-party application and result data is generated. The result data is transmitted to the cloud-based processor 514, and then is provided to output device 506, at the source end, via the WAN 510 and the network components 512. At the source end, the result data is presented to the user in a human intelligible form, via the output device. In the instant example, the output device 506 includes a display device, and the result data is displayed via the display device. Optionally, the result data is further processed prior to being provided to the output device 506. For instance, the result data is provided to the second third-party server for being processed in accordance with the second third-party application or the result data is processed using an application for processing video and/or audio data that is in execution on the cloud-based processor 514.

When the captured video and/or audio data is “subscribed” to the cloud-based processor 514, the user-selected application may be used to process the video and/or audio data continuously. Optionally, result data is transmitted from the cloud-based processor to the output device in a substantially continuous manner, or only when a predetermined trigger event is detected.

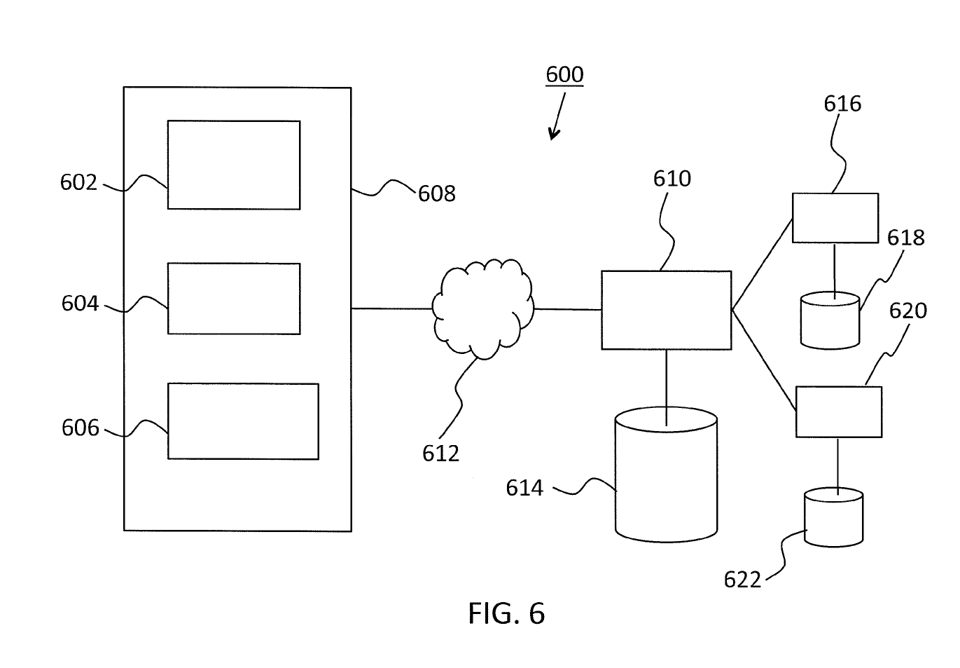

Referring now to FIG. 6, shown is a simplified block diagram of a system in accordance with another embodiment of the instant invention. The system 600 includes a sensor 602, a user interface 604 and an output device 606, such as for instance at least one of a display device and a sound-generating device or speaker, all of which are disposed at a source end. In this specific and non-limiting example the sensor 602 is an integrated video camera of a consumer electronic device 608, such as for instance one of a smart phone, a tablet computer, a laptop computer, a desktop computer, an HDTV, etc. Additionally, the user interface 604 and the output device 606 are embodied in the consumer electronic device 608. The user interface 604 comprises, by way of an example, a touch-screen display portion of the consumer electronic device 608. Optionally, the consumer electronic device 608 further includes a not illustrated data storage device for storing a local copy of the captured sensor data at the source end.

In the system that is shown in FIG. 6 the consumer electronic device 608 is in communication with a cloud-based processor 610 via a wide area network (WAN) 612. A complete description of the wired and/or wireless infrastructure that connects the consumer electronic device 608 to the WAN 612 has been omitted in FIG. 6, in the interest of clarity. The cloud-based processor 610 is in communication with a cloud-based data storage device 614. In an embodiment, the cloud-based processor 610 and cloud-based data storage device 614 are embodied in a network server. Optionally, the cloud-based processor 610 comprises a plurality of processors, such as for instance a server farm. Optionally, the cloud-based data storage device 614 comprises a plurality of separate network storage devices. The cloud-based data storage device 616 has stored thereon a database relating to third party applications for processing video and/or audio data.

Referring still to FIG. 6, the cloud-based processor is in communication with a first third-party server 616 having a first local data store 618 and with a second third-party server 620 having a second local data store 622. At least a first third-party application for processing video and/or audio data is stored on the first local data store 618 and at least a second third-party application for processing video and/or audio data is stored on the second local data store 622. The first third-party application is executable by a processor of the first third-party server 616 for processing video and/or audio data that are received from the source end via the cloud-based processor 610. Similarly, the second third-party application is executable by a processor of the second third-party server 620 for processing video and/or audio data that are received from the source end via the cloud-based processor 610. Optionally the first third-party application and/or the second third party application process video and/or audio data that are generated using another application for processing video and/or audio data. That is to say, optionally the video and/or audio data are processed using a plurality of the applications in series.

The operation of the system that is shown in FIG. 6 is substantially the same as the operation of the system that is shown in FIG. 5. During use, the sensor 602 is used to capture video data relating to an event that is occurring at the source end. The captured video data is provided to the cloud-based processor 610 via the WAN 612. Optionally, the captured video data is “subscribed” to the cloud-based processor 610, in which case the captured video data is transmitted continuously or intermittently from the source end to the cloud-based processor 610. Alternatively, the captured video data is provided to the cloud-based processor 610 “on-demand,” such as for instance only when processing of the captured video data is required. Using the user interface 604, a user selects the first third-party application, which is stored on the first local data store 618. Alternatively, the user selects the second third-party application, which is stored on the second local data store 622. For instance, the user interface 604 comprises a touch-screen display portion of a computing device, upon which ions that are representative of the available applications for processing video and/or audio data are displayed to the user. By touching an icon that is displayed on the touch-screen, the user provides an indication for selecting a desired application for processing the captured video data. A control signal is then transmitted from the source end to the cloud-based processor 610 via the WAN 612. The cloud-based processor 610 accesses the database that is stored on the cloud-based data storage device 614 and retrieves the location of the first third-party application. Subsequently, the cloud-based processor passes the captured video data, or at least a portion thereof, to the first third party server 616 with a request for processing the captured video data using the first third-party application. The first third-party server 616 receives the captured video data and launches the first third-party application, which is stored on the first local data store 618. The captured video data is processed in accordance with the first third-party application and result data is generated. The result data is transmitted to the cloud-based processor 610, and then is provided to output device 606, at the source end, via the WAN 612. At the source end, the result data is presented to the user in a human intelligible form, via the output device. In the instant example, the output device 606 includes a display device, and the result data is displayed via the display device. Optionally, the result data is further processed prior to being provided to the output device 606. For instance, the result data is provided to the second third-party server 620 for being processed in accordance with the second third-party application or the result data is processed using an application for processing video and/or audio data that is in execution on the cloud-based processor 610.

When the captured video and/or audio data are “subscribed” to the cloud-based processor 610, the selected application may be used to process the video and/or audio data continuously. Optionally, result data is transmitted from the cloud-based processor 610 to the output device in a substantially continuous manner, or only when a predetermined trigger event is detected.

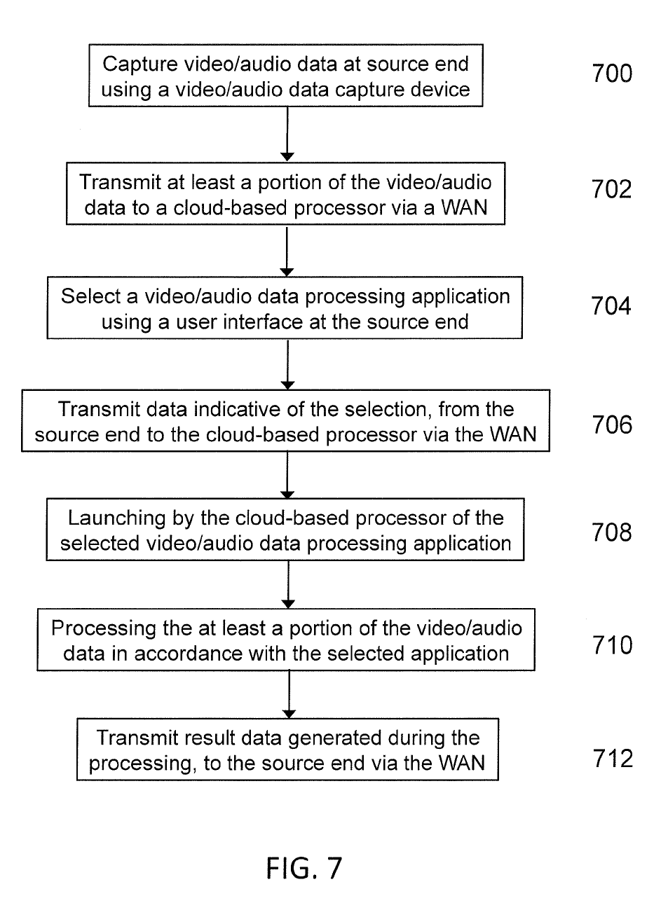

Referring now to FIG. 7, shown is a simplified flow diagram of a method according to an embodiment of the instant invention. At 700 a sensor disposed at a source end is used for capturing video and/or audio data relating to an event that is occurring at the source end. At 702 at least a portion of the captured video and/or audio data is transmitted from the source end to a cloud-based processor via a wide area network (WAN). At 704, using a user interface that is disposed at the source end, an application for processing the video and/or audio data is selected from a plurality of different applications. In particular, the selected application is for being executed on the cloud-based processor for processing the least a portion of the captured video and/or audio data. At 706 data indicative of the user selection is transmitted from the source end to the cloud-based processor via the WAN. At 708, in response to receiving the data indicative of the user selection at the processor, the selected application is launched. At 710 the least a portion of the captured video and/or audio data is processed in accordance with the selected application, so as to generate result data. At 712 the generated result data is transmitted from the cloud-based processor to the source end via the WAN.

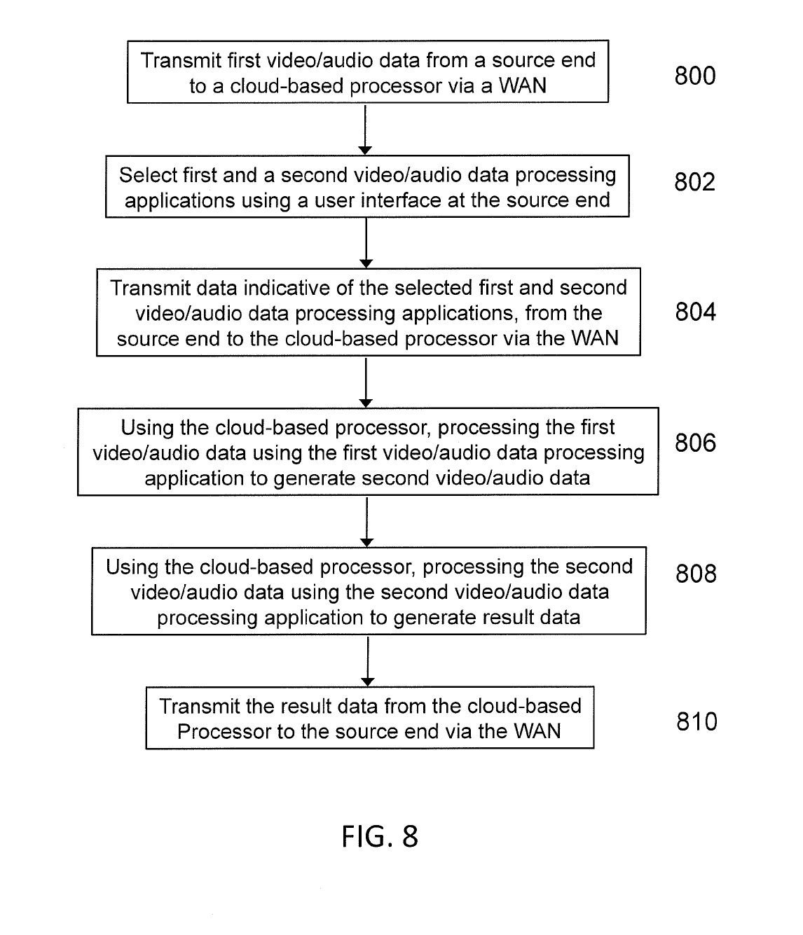

Referring now to FIG. 8, shown is a simplified flow diagram of a method according to an embodiment of the instant invention. At 800 first video and/or audio data is transmitted from a source end to a cloud-based processor via a wide area network (WAN). At 802, a user interface at the source end is used to select, from a plurality of applications for processing video and/or audio data, a first application for processing the first video and/or audio data to generate second video and/or audio data, and a second application for processing the second video and/or audio data to generate results data. At 804 data indicative of the selected first and second applications are transmitted from the source end to the cloud-based processor via the WAN. At 806, using the cloud-based processor, the first video and/or audio data are processed using the first application to generate the second video and/or audio data. At 808, using the cloud-based processor, the second video and/or audio data are processed using the second application to generate the results data. At 810 the results data is transmitted from the cloud-based processor to the source end via the WAN.

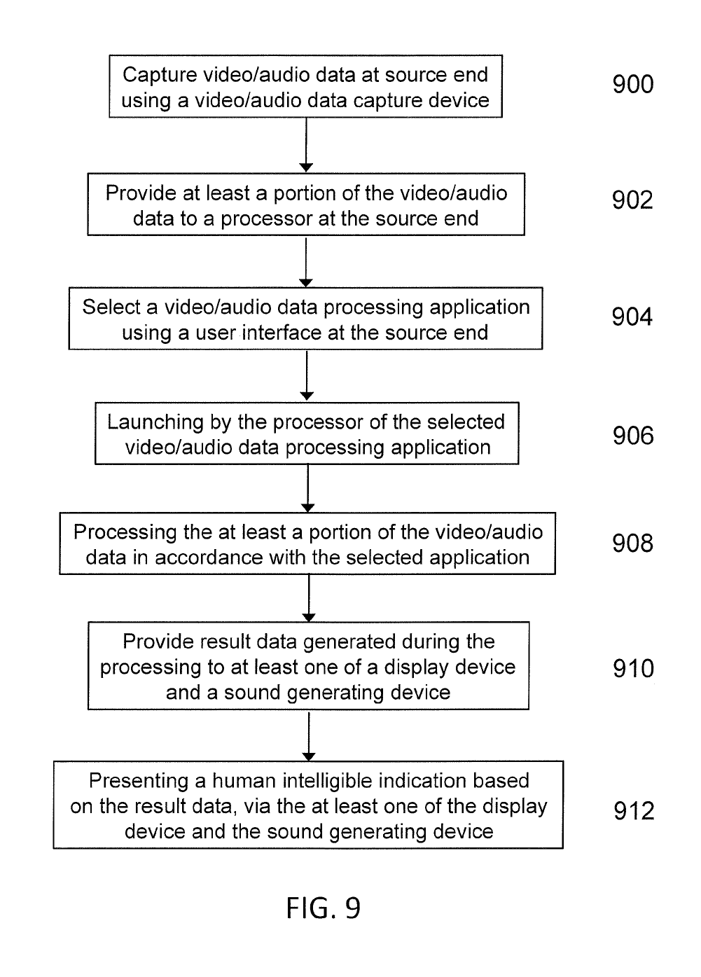

Referring now to FIG. 9, shown is a simplified flow diagram of a method according to an embodiment of the instant invention. At 900, using a sensor, video and/or audio data are captured relating to an event that is occurring locally with respect to the sensor. At 902 at least a portion of the captured video and/or audio data is provided from the sensor to a processor that is in communication with the sensor. At 904 a user uses a user interface that is in communication with the processor to select an application from a plurality of different applications that are stored on a data store, the data store being in communication with the processor and each of the plurality of different applications being for processing video and/or audio data. In particular, the selected application is for being executed by the processor for processing the least a portion of the captured video and/or audio data. At 906 the processor launches the selected application. At 908 the least a portion of the captured video and/or audio data is processed using the processor and in accordance with the selected application, to generate result data. At 910 the result data are provided to at least one of a display device and a sound-generating device. At 912 a human intelligible indication based on the result data is presented to the user, via the at least one of a display device and a sound generating device.

The systems that are described in the preceding paragraphs with reference to FIGS. 1-6 support custom processing of video and/or audio data that are captured using, for instance, mass-market consumer electronic devices. Although the examples that are described with reference to FIGS. 1-6 relate to the capture and processing of video data, optionally a microphone or other sensor is used instead of a video camera or in cooperation with a video camera for capturing video and/or audio data at the source end. Further, a specific example is provided in which captured video data is processed using a first application (“speed trap” application) and a result of the processing is provided for being processed using a second application (“license plate extraction” application). Of course, optionally more than two applications are used in series, such that the result of processing using each application is provided to a next application in the series for further processing. Alternatively, the same video data is processed using two different applications in parallel, and the result data from each of the applications is provided to a next application for being further processed thereby. Other variations may be envisaged by one of ordinary skill in the art.

The applications that are available on the cloud-based data storage device 116, 214, 318, 414, 520/522 or 618/620 may include applications relating to security applications, surveillance applications, social media applications, or video editing/augmenting/modifying applications, to name just a few examples. As noted above, results of processing using an application may result in modifying the captured video and/or audio data, such as for instance overlaying text information on video data or overlaying leprechaun costumes or other supplemental content on the images of individuals in the video data, etc. The applications may be submitted by third parties, and may be offered free of charge or require making a purchase. The availability of applications may change with time depending on popularity, and new applications may be added regularly in order to satisfy different processing needs as they emerge.

According to at least some embodiments of the instant invention, the user may be remote from the sensor at the source end during the selection of processing applications and presenting of the result data. For instance, a user travelling with his or her smart phone may use the display of the smart phone to monitor video data that is being captured using a video camera located at the user's residence. Upon noticing suspicious activity in the video, the user selects a first application to detect movement and the video data is processed in accordance with the first application. The user views the results of processing using the first application via the display of the smart phone. The user may then select a second application to search for a face anywhere movement has been detected by the first application, and to capture a useable image of the face. Subsequently, the user may view the captured image of the face via the display of the smart phone.

Numerous other embodiments may be envisaged without departing from the scope of the invention.

1. A system comprising:
a sensor for capturing sensor data comprising at least one of video data and audio data and for providing at least a portion of the captured sensor data via a data output port thereof;
a data store having stored thereon machine readable instruction code comprising a plurality of different applications for least one of video data and audio data;
a processor in communication with the sensor and with the data store; and
a user interface in communication with the processor, the user interface for receiving an indication from the user and for providing data relating to the indication to the processor, the data for selecting at least one of the plurality of different applications for being executed by the processor for processing the provided at least a portion of the captured sensor data.

2. The system according to claim 1 wherein the sensor and the user interface are disposed at a source end, the data store and the processor are disposed in the cloud, and the at least a portion of the captured sensor data and the data relating to the indication are transmitted from the source end to the processor via a wide area network (WAN).

3. The system of claim 2 wherein the WAN is the Internet.

4. The system of claim 3 wherein the sensor is an Internet Protocol (IP) video camera.

5. The system of claim 4 wherein the machine readable instruction code comprises a plurality of different video analytics processing applications.

6. The system of claim 1 wherein the sensor, the user interface, the data store and the processor are in communication with one another via a local area network.

7. The system of claim 1 wherein the sensor the user interface and the processor are disposed at a source end and the data store is disposed in the cloud, and wherein machine readable instruction code of the selected at least one of the plurality of different applications is transmitted from the data store to the processor via a wide area network (WAN).

8. The system of claim 1 wherein the sensor, the data store, the processor and the user interface are embodied in a consumer electronic device.

9. The system of claim 8 wherein the consumer electronic device is a high definition television (HDTV).

10. The system of claim 8 wherein the consumer electronic device is a smart phone.

11. A method comprising:
using a sensor disposed at a source end, capturing sensor data comprising at least one of video data and audio data relating to an event that is occurring at the source end;
transmitting at least a portion of the captured sensor data from the source end to a cloud-based processor via a wide area network (WAN);
using a user interface that is disposed at the source end, selecting an application from a plurality of different applications for processing at least one of video data and audio data, the selected application for being executed on the cloud-based processor for processing the at least a portion of the captured sensor data;
transmitting data indicative of the user selection from the source end to the cloud-based processor via the WAN;
in response to receiving the data indicative of the user selection at the processor, launching the selected application;
processing the least a portion of the captured sensor data in accordance with the selected application to generate result data; and
transmitting the generated result data from the cloud-based processor to the source end via the WAN.

12. The method of claim 11 wherein the sensor data is video data, and comprising displaying the generated result data in a human intelligible form via a display device that is disposed at the source end.

13. The method of claim 12 wherein transmitting the at least a portion of the captured sensor data is performed in an on-demand fashion.

14. The method of claim 12 wherein transmitting the at least a portion of the captured sensor data is performed in an automated subscribed fashion.

15. The method of claim 11 wherein the sensor is a consumer electronic device.

16. The method of claim 15 wherein the consumer electronic device is a high definition television (HDTV).

17. The method of claim 15 wherein the consumer electronic device is a smart phone.

18. A method comprising:
transmitting first data comprising at least one of video data and audio data from a source end to a cloud-based processor via a wide area network (WAN);
using a user interface at the source end, selecting from a plurality of different applications for processing at least one of video data and audio data:
a first application for processing the first data to generate second data comprising at least one of video data and audio data; and
a second application for processing the second data to generate results data;
transmitting data indicative of the selected first and second applications from the source end to the cloud-based processor via the WAN;
using the cloud-based processor, processing the first data using the first application to generate the second data;
using the cloud-based processor, processing the second data using the second application to generate the results data; and
transmitting the results data from the cloud-based processor to the source end via the WAN.

19. The method of claim 18 comprising, prior to transmitting the first data from the source end to the cloud-based processor, using a sensor disposed at the source end and capturing at least one of video data and audio data relating to an event that is occurring at the source end, wherein the first data comprises at least a portion of the captured at least one of video data and audio data.

20. The method of claim 19 wherein the captured at least one of video data and audio data is video data, and comprising displaying the generated result data in a human intelligible form via a display device that is disposed at the source end.

21. The method of claim 18 wherein transmitting the first data is performed in an on-demand fashion.

22. The method of claim 18 wherein transmitting the first data is performed in an automated subscribed fashion.

23. The method of claim 18 wherein the sensor is a consumer electronic device.

24. The method of claim 23 wherein the consumer electronic device is a high definition television (HDTV).

25. The method of claim 23 wherein the consumer electronic device is a smart phone.

26. A method comprising:
using a sensor, capturing sensor data comprising at least one of video data and audio data relating to an event that is occurring locally with respect to the sensor;
providing at least a portion of the captured sensor data from the sensor to a processor that is in communication with the sensor;
using a user interface in communication with the processor, selecting by a user an application from a plurality of different applications for processing at least one of video data and audio data that are stored on a data store that is in communication with the processor, the selected application for being executed by the processor for processing the at least a portion of the captured sensor data;
launching by the processor the selected application;
processing by the processor the least a portion of the captured sensor data in accordance with the selected application, to generate result data;
providing the result data to at least one of a display device and a sound generating device; and
presenting to the user, via the at least one of a display device and a sound generating device, a human intelligible indication based on the result data.

27. The method of claim 26 wherein the sensor, the user interface and the at least one of a display device and a sound generating device are disposed at a source end, the data store and the processor are disposed in the cloud, and wherein providing the at least a portion of the captured sensor data and providing the result data comprises transmitting the at least a portion of the captured sensor data and transmitting the result data, respectively, via a wide area network (WAN).

28. The method of claim 27 wherein the WAN is the Internet.

29. The method of claim 28 wherein the sensor is an Internet (IP) video camera.

30. The method of claim 26 wherein the sensor, the user interface, the at least one of a display device and a sound generating device, the data store and the processor are in communication with one another via a local area network.

31. The method of claim 26 wherein the sensor, the user interface, the at least one of a display device and a sound generating device, the data store and the processor are embodied in a consumer electronic device.

32. The method claim 31 wherein the consumer electronic device is a high definition television (HDTV).

33. The method of claim 31 wherein the consumer electronic device is a smart phone.

34. A system comprising:
a sensor for capturing sensor data comprising at least one of video data and audio data and for providing at least a portion of the captured sensor data via a data output port thereof;
a remote server in communication with the sensor via a wide area network (WAN);
a data store in communication with the remote server and having stored thereon a database containing data relating to storage locations of a plurality of different applications for processing at least one of video data and audio data; and
a user interface in communication with the remote server, the user interface for receiving an indication from the user and for providing data relating to the indication to the remote server, the data for selecting at least one of the plurality of different applications for processing the provided at least a portion of the captured sensor data,
wherein the storage locations are indicative of other servers that are in communication with the remote server and a storage location of the selected at least one of the plurality of different applications is a first server of the other servers, and
wherein during use the remote server provides the at least a portion of the captured sensor data to the first server of the other servers for being processed according to the selected at least one of the plurality of different applications.

35. A method comprising:
using a sensor, capturing sensor data comprising at least one of video data and audio data relating to an event that is occurring locally with respect to the sensor;
providing at least a portion of the captured sensor data from the sensor to a remote server that is in communication with the sensor via a wide area network (WAN);
using a user interface that is in communication with the remote server, selecting by a user an application from a plurality of different applications for processing at least one of video data and audio data;
determining by the remote server a storage location of the selected application using a database containing data relating to storage locations of each of the plurality of different applications, the storage locations being indicative of other servers that are in communication with the remote server; and
providing the at least a portion of the captured sensor data from the remote server to a first server that is determined to have stored in association therewith the selected application.

36. A system comprising:
a sensor for capturing sensor data comprising at least one of video data and audio data and for providing at least a portion of the captured sensor data via a data output port thereof;
a data store having stored thereon machine readable instruction code comprising a plurality of different applications for processing at least one of video data and audio data;
at least one processor in communication with the sensor and with the data store; and
a user interface in communication with the at least one processor, the user interface for receiving an indication from the user and for providing data relating to the indication to the at least processor, the data for selecting at least one of the plurality of different applications for being executed by the at least one processor for processing the provided at least a portion of the captured sensor data.

37. The system of claim 36 wherein the at least one processor comprises a first cloud-based processor associated with a broker system and a second cloud-based processor in communication with the broker system, and wherein the at least one of the plurality of different applications is in execution on the second cloud-based processor.

38. The system of claim 36 wherein the at least one processor comprises one cloud-based processor, and wherein the at least one of the plurality of different applications is in execution on the one cloud-based processor.
